(19) United States
(12) Patent Application Publication
(10) Pub. No.: US 2026/0228195 A1
(43) Pub. Date: Aug. 6, 2026

(54) RANGE ERROR DETECTION AND CORRECTION IN TABLE DATA

(71) Applicant: International Business Machines Corporation, Armonk, NY (US)

(72) Inventors: Minhao YAN, Ithaca, NY (US); Bing ZHANG, San Jose, CA (US); Pawan Raghunath CHOWDHARY, San Jose, CA (US); Taiga NAKAMURA, Sunnyvale, CA (US)

(21) Appl. No.: 19/044,863

(22) Filed: Feb. 4, 2025

(51) Int. Cl. G06F 16/21; G06F 18/2413

(52) U.S. Cl. CPC G06F 16/217; G06F 18/24147

(57) ABSTRACT

Method and apparatus for using similarity analysis, and a plurality of different machine learning algorithms to detect parsing errors or missing data in data tables. The AI system can then generate a new data table with the errors corrected. The corrected data table can include predicted values of what the original data table was missing. The AI system offers an improvement for generating data tables with range values where such data tables are normally produced with errors and missing information. The AI system provides an automatic way of correcting errors, via the generation of a new data table.

### BACKGROUND

The present invention relates to data tables containing range data, and more specifically, to generating corrected data tables from data tables that initially have missing data or parsing errors. A data table containing range data represents a collection of records where one or more columns define a range of values, rather than just a single value. Ranges can be expressed using a pair of boundaries, such as a start and end value, which could represent numbers, dates, or other measurable quantities. Such tables can be used to represent intervals in scheduling, pricing, geographic coordinates, or other datasets where values span a range. The rows or columns of these tables can include attributes or labels to describe the context or meaning of each range.

### SUMMARY

According to some embodiments, a method includes: determining there is data missing from a first data table by evaluating similarity between neighboring cells of the first data table, where evaluating the similarity includes: extracting data from header cells of the first data table; interpreting a meaning of the extracted data from the header cells; and predicting the meaning of numerical data under the header cells based on the interpreted meaning of the extracted data; identifying a type of range data present in the first data table; predicting values of the missing data of the first data table by performing an analysis on the cells containing the missing data, and the identified type of range data present in the first data table; and generating using the predicted values, a second data table, where the second data table is a completed version of the first data table.

According to other embodiments, a computer program product for generating a data table, the computer program product including: a computer-readable storage medium having computer-readable program code embodied therewith, the computer-readable program code executable by one or more computer processors configured to perform operations including: determining there is data missing from a first data table by evaluating similarity between neighboring cells of the data table, where evaluating the similarity includes: extracting data from header cells of the first data table; interpreting a meaning of the extracted data from the header cells; and predicting a meaning of numerical data under the header cells based on the interpreted meaning of the extracted data; identifying a type of range data present in the first data table; predicting values of the missing data of the first data table by performing an analysis on the cells containing the missing data, and the identified type of range data present in the first data table; and generating using the predicted values, a second data table, where the second data table is a completed version of the first data table.

According to other embodiments, a computer system for generating a data table, the computer system including: one or more computer processors; one or more computer readable storage media; and program instructions stored on the computer readable storage media for execution by at least one of the one or more processors, the program instructions including: determining data is missing from a first data table by evaluating similarity between neighboring cells of the data table, where evaluating the similarity comprises: extracting data from header cells of the first data table; interpreting a meaning of the extracted data from the header cells; and predicting a meaning of numerical data under the header cells based on the interpreted meaning of the extracted data; identifying a type of range data present in the first data table; predicting values of the missing data of the first data table by performing an analysis on the cells containing the missing data, and the identified type of range data present in the first data table; and generating using the predicted values, a second data table, where the second data table is a completed version of the first data table.

### BRIEF DESCRIPTION OF THE DRAWINGS

FIG. 1 illustrates a functional block diagram illustrating a networked environment, in accordance with an example embodiment of the present invention.

FIG. 2 illustrates an artificial intelligence (AI) system for generating a corrected data table, according to some embodiments.

FIG. 3 illustrates a flowchart of the AI system, according to some embodiments.

FIG. 4 illustrates a flowchart of the AI system, according to some embodiments.

FIG. 5 illustrates examples of data tables, according to some embodiments.

FIG. 6 illustrates an example of a second generated data table, according to some embodiments.

### DETAILED DESCRIPTION

Embodiments herein relate to an AI system that generates a data table. The AI system receives a parsed data table, where a parsed data table can be a structured representation of raw data that has been processed and organized into a readable format. A parsed data table can have rows and columns. Using a plurality of AI scanning techniques, the AI system is able to detect errors or missing data from the parsed data table. In response to detecting the errors, the AI system then generates a second data table, where the errors detected are corrected and missing values are filled in.

The AI system uses similarity analysis, and a plurality of different machine learning algorithms to detect inconsistencies caused by document parsing errors or missing data. The AI system can then generate a new data table with the inconsistencies corrected. The corrected data table can include values that are predicted values of what the original data table was missing. The AI system offers an improvement for generating data tables with range values where such data tables are normally produced with errors and missing information. The AI system provides an automatic way of correcting errors, via the generation of a new data table.

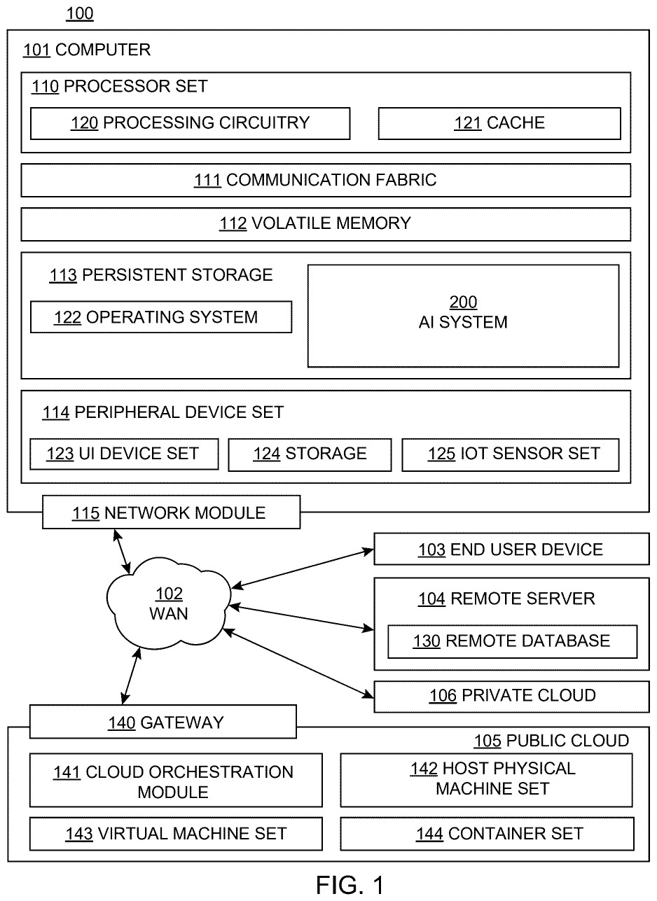

With reference now to FIG. 1.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as AI system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

A data table 210 is received by an AI system 200. The AI system 200 contains a table error detector 220, a range data identifier 230, and a data table generator 240. Collectively, these components of the AI system 200 generate a second data table 250.

The table error detector 220 uses a missing value detector 225 to parse the data table 210 and determine if there are values that should be present, that are currently not present. The missing data classifier 227 of the missing value detector 225 determines the type of data that is missing. The data type can be range data or general data. The data types are described in more detail below. The parsing error detector 223 of the table error detector 220 determines whether or not a parsing error occurred in the data table. A parsing error includes a failure to interpret or process special characters and their meaning within the data table 210.

The missing value detector 225 performs a similarity analysis on the cells of the data in the different cells of the data table 210. The similarity analysis can involve comparing the content of cells across rows or columns of the data table to identify patterns, anomalies or inconsistencies, which can help detect missing values. This process carried out by the missing value detector 225 assesses the relationships between data entries by measuring similarities in value distributions, ranges or other attributes. For example, if a column of the data table 210 consistently contains numerical values within a certain range, but a few cells are blank or deviate significantly, this allows the missing value detector 225 to flag those cells as having missing values. Techniques such as distance metrics (cosine similarity, Euclidian similarity, etc.), similarity analysis can flag gaps by highlighting rows or columns that diverge from expected patterns.

The missing data classifier 227 classifies the detected missing data as either regular/general missing data, or range missing data. This can be done by comparing the format of the cells where data is detected to be missing by the missing value detector 225. Regular missing data refers to individual cells in the data table 210 that are blank, null, or otherwise unpopulated, representing the absence of general values. Range missing data occurs when part of a defined range is incomplete or missing, such as a gap within a sequence interval (e.g. a date range missing certain dates). Regular missing data can affect isolated entries of the data table 210, whereas range missing data impacts continuous span entries of the data table 210.

The parsing error detector 223 determines if there is an error in the data contained in the data table 210. The parsing error detector 223 ensures the meaning of special characters in the data table matches the meaning of the data that corresponds to the special character in the data table 210. For example, if the parsing error detector 223 identifies a dollar sign, it checks to make sure the corresponding data under the header that contains the dollar sign refers to money. In one embodiment, it accomplishes this by detecting a special character within the data table, interpreting the meaning of numerical data following the special character, and determining the meaning of the special character used in the data table based on the interpreted meaning of the numerical data following the special character. For example, if the parsing error detector 223 detects a dollar sign, it can ensure the corresponding data under the header refers to money by checking the formatting (e.g., checking to see if there are two numbers following the decimal, etc.). Similarly, the meaning of the numerical data can be determined by extracting data from a header cell of the data table, interpreting the meaning of the extracted data from the header cell, and predicting the meaning of special character used under the header cell based on the interpreted meaning of the extracted data.

The range data identifier 230 is triggered if the table error detector 220 determines that there is missing range data, or an error pertaining to range data of the data table 210. In one embodiment, the range data classifier 235 of the range data identifier 230 identifies at least three different types of range data. The first being formatted range data, the second being single range data, and the last being comprised range data.

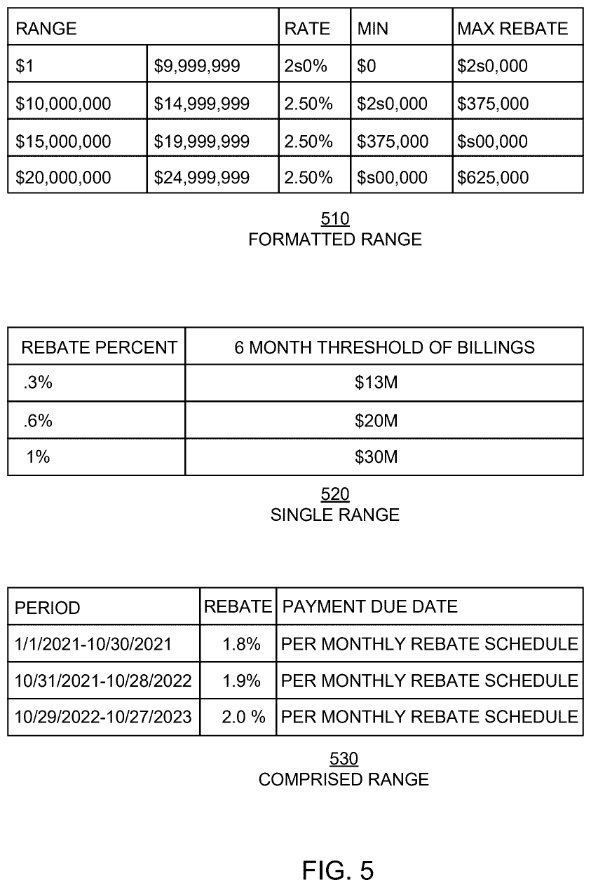

Formatted range data is arranged in the data table with a lower bound column of the range data, and an upper bound column of the range data. Single range data is arranged in the data table as one number indicating a limit in one cell of the data table. Comprised range data is arranged in the data table as multiple numbers indicating a limit in one cell of the data table. Examples of the different types of range data are illustrated in FIG. 5.

The range data classifier 235 uses its column checker 232, numerical bound checker 237, and range type predictor 234 to classify the type of range data that is missing.

The column checker 232 parses the columns of the data table 210 to understand the data table's 210 structure and content. The column checker 232 examines the column headers, and analyzes the data type (numeric, text or date, etc.) within the columns of the data table 210. For range data classifying, in one embodiment the column checker 232 identifies columns that might represent boundaries, such as a “start” or “end” column, or the column checker 232 can identify patterns on how data is grouped. The column checker 232 can also check for consistency in how values are distributed across rows, flagging columns that may work together to define a range.

The numerical bound checker 237 assess the minimum and maximum values within the relevant cells identified by the column checker 232. For potential range data, the numerical bound checker 237 may evaluate whether values in certain columns of the data table 210 behave as lower or upper bounds (e.g. if all values in one column are less than or equal to corresponding values in another column). Additionally, the numerical bound checker 237 can look for outliers or irregularities that could indicate missing or misinformed data.

The range type predictor 234 uses the insights from the column checker 232 and the numerical bound checker 237 to predict the type of range data that is missing. For example, if the data from the column checker 232 and the numerical bound checker 234 indicates there is a limit or boundary in a single column of the data table 210, the range data is classified as “single.” If the data from the data from the column checker 232 and the numerical bound checker 234 indicates separate columns with start and end values, the data is classified as “formatted.” If data from the column checker 232 and the numerical bound checker 234 indicates multiple numbers or ranges found within single cells of the data table 210, the data is classified as “comprised.”

The data table generator 240 uses information from the table error detector 220 and the range data identifier 230 to generate a second data table 250. Within the data table generator 240 is the missing value predictor 242 and the parsing value predictor 246.

If a parsing error is detected by the parsing error detector 223 of the table error detector 220, the parsing value predictor 246 of the data table generator 240 is triggered. In one embodiment, the parsing value predictor 246 uses a similarity analysis, described above, to extract and understand the context from the headers of the data table 210 from the parsing error detector 223 to then predict the correct values. For example, if the parsing error detector 223 extracts the word “money” from the header cell of a column, but the special characters in the column include a percentage symbol rather than a dollar sign, the parsing value predictor 246 can predict that the percentage sign is a mistake, and that the accurate special character is a dollar sign.

If the table error detector 220 indicates that there is a missing value, depending on how the missing data classifier 227 classifies the missing value, either the regular missing value predictor 243 or the range missing value predictor 247 of the missing value predictor 242 is initiated.

The regular missing value predictor 243 can apply a K nearest neighbors (KNN) algorithm to the neighboring cells of the missing data of the data table, and derive a predicted value of the regular missing data from the KNN algorithm. In one embodiment, the KNN algorithm is a non-parametric, supervised learning classifier, which uses proximity to make classifications or predictions about the grouping of an individual data point.

The range missing value predictor 247 can evaluate the similarity between neighboring cells and predicting, using the evaluated similarity, a value of the range missing data. The similarity analysis is described above.

The second data table 250 is a new data table generated with the missing values from the data table 210 filled in with the values predicted by the data table generator 240, or with corrected values. The predicted corrected values are also predicted by the data table generator 240. The similarity analysis can involve comparing the content of cells across rows or columns of the data table to identify patterns, anomalies or inconsistencies, which can help detect missing values. This process carried out by the missing value detector 225 assesses the relationships between data entries by measuring similarities in value distributions, ranges or other attributes. For example, if a column of the data table 210 consistently contains numerical values within a certain range, but a few cells are blank or deviate significantly, this allows the missing value detector 225 to flag those cells as having missing values.

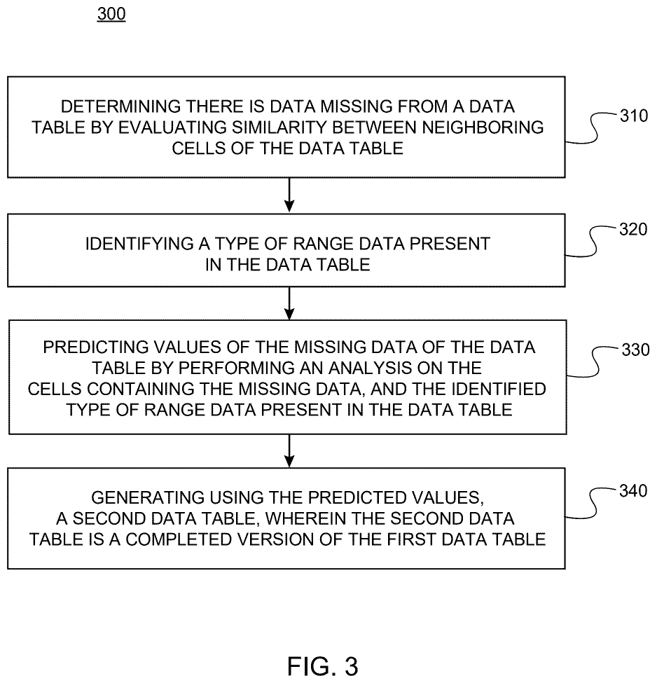

FIG. 3 illustrates a flow diagram 300 of generating the second data table 250.

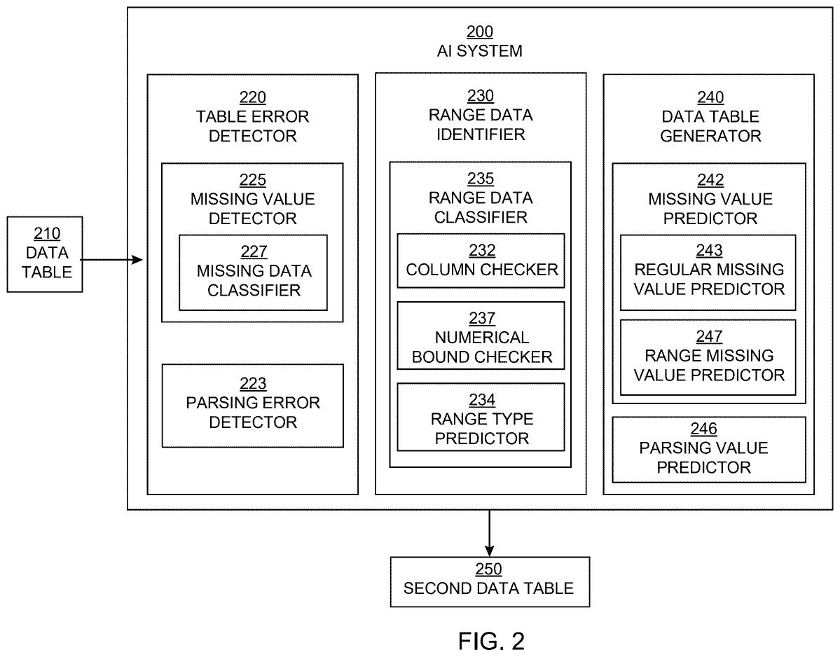

At block 310, the table error detector 220 determines there is data missing from the data table 210 by evaluating the similarity between neighboring cells of the data table. As described in FIG. 2, evaluating the similarity between neighboring cells of the data table can include comparing adjacent entries of the data table to identify patterns, relationships or anomalies. This comparison can focus on numeric proximity, textual similarity, or categorical alignment. For example, in a column of numerical data, the similarity analysis can check whether the differences between neighboring values remain within a predictable range, flagging sudden jumps in values or outliers. Highlighting inconsistencies can detect data entry errors or missing values in the data table.

At block 320 the range data identifier identifies the type of range data present in the data table. As discussed in FIG. 2, the range data classifier 235 checks the columns, and numerical bounds of the data table to predict the type of range data is present in the data table. Also discussed in FIG. 2, there are at least three types of range data that can be detected. The types of range data include single range data, comprised range data, and formatted range data. Examples of the types of range data are illustrated in FIG. 5.

At block 330 the data table generator predicts the values of the missing data of the data table 210, by performing an analysis on the cells containing the missing data, and by using information from the range data identifier 230 that indicates the type of range data present in the data table. As discussed in FIG. 2, the missing data from the data table can be classified as either regular missing data or range missing data. If it is indicated that there is regular missing data from the data table, the missing value predictor 242 initiates its regular missing value predictor 243, which in one embodiment performs a KNN analysis to provide predictions of what the missing values could be. If it is indicated that there is range missing data by the missing data classifier 227, the range missing value predictor 247 initiates a similarity analysis of the cells of the data table 210 to provide predictions of what the missing range values could be.

At block 340, the AI system 200 uses the predicted values generated at the data table generator 240 to generate a second data table, where the second data table is a completed version of the first data table. The second data table is a new data table that includes the values from the first data table 210, but also has the missing values filled in with the predicted values from the data table generator 240, and incorrect values corrected, also according to the predictions of the data table generator 240.

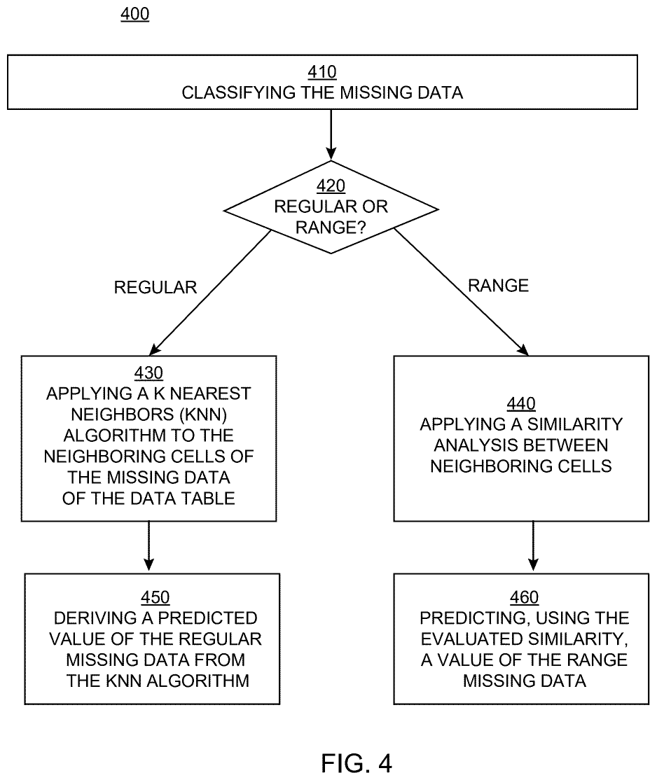

FIG. 4 illustrates a flow diagram 400 of predicting missing values of regular data and predicting missing values of range data.

At block 410 the missing data classifier 227 classifies the missing data. As discussed in FIG. 2, the missing data classifier 227 can apply a similarity analysis to the cells of the data table 210. Using the results of the similarity analysis, the missing data classifier 227 can determine whether the missing data is regular data or range data.

At the decision block 420, the missing value predictor 242 registers the findings from the missing data classifier 227, and determines whether to run an algorithm for predicting regular missing data or range missing data.

At block 430, the missing value predictor 242 determines that it should be predicting regular missing data. As described in FIG. 2, upon determining that it is regular missing data that should to be predicted, the missing value predictor 242 applies a KNN algorithm to the neighboring cells of the missing data of the data table.

At block 450, the missing value predictor 242 uses the results from the KNN algorithm to derive a predicted value for the regular missing data. This process is described in FIG. 2.

At block 440 the missing value predictor 242 determines that it should be predicting range missing data. As described in FIG. 2, upon determining that it is range missing data that should to be predicted, the missing value predictor 242 applies a similarity analysis to the neighboring cells of the missing data of the data table.

At block 460, similar to block 450, the missing value predictor 242 uses the results from the similarity analysis to predict a value for the range missing data. This process is also described in FIG. 2.

FIG. 5 illustrates examples of different types of range data, as described in FIG. 2. FIG. 5 shows a data table 510 with formatted range data, where formatted range data is arranged in the data table 520 with a lower bound column of the range data, and an upper bound column of the range data, single range data, where single range data is arranged in the data table 520 as one number indicating a limit in one cell of the data table, where the limit indicates a value the data is bound by, and comprised range data, where comprised range data is arranged in the data table 530 as multiple numbers indicating a limit in one cell of the data table, where the limit indicates a value the data is bound by.

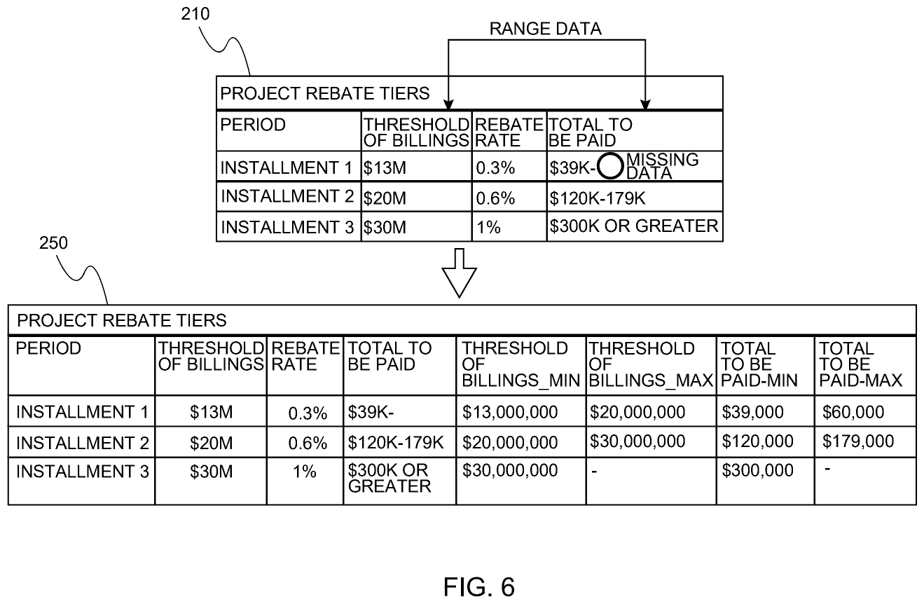

FIG. 6 illustrates an example of what a data table 210 that is presented to the AI system 200 may look like. The example shows an example of a data table with missing comprised range data. It also shows what the second data table 250 generated by the AI system could look like, containing values that were missing from the data table 210 that were predicted by the AI system, following the process described in the above application.

As described in FIG. 3, a similarity analysis between the neighboring cells of the data table 210 is performed to determine there is data missing. Once it is known to the AI system 200 that data is missing, another similarity analysis is performed to determine the type of data found in the data table. The similarity analysis will identify the table as having comprised range data, and then predict values that could complete the data table. Once values are predicted, the second data table 250 is generated.

While the foregoing is directed to embodiments of the present invention, other and further embodiments of the invention may be devised without departing from the basic scope thereof, and the scope thereof is determined by the claims that follow.

1. A method comprising:
evaluating, using an artificial intelligence (AI) system, a first data table to detect missing and error data and automatically correct data of the first data table, wherein the missing data comprises null cell content and the error data further comprises inconsistent and anomalous cell content, and wherein evaluating the first data table comprises:
performing a first similarity analysis of cell content of a plurality of neighboring cells of the first data table to identify data patterns, relationships, and anomalies that indicate one or more cells containing the missing and error data, wherein performing the first similarity analysis comprises:
interpreting a meaning of the extracted data from the plurality of neighboring cells, header cells; of the first data table, and corresponding numerical data of cells under the header cells to detect the missing and error data based on the interpreted meaning of the extracted data;
evaluating the plurality of neighboring cells of the first data table to identify a type of range data present in the one or more cells containing the missing and error data in the first data table;
predicting corrected values of the one or more cells containing the missing and error data of the first data table by performing a second similarity analysis based on the one or more cells containing the missing and error data, the plurality of neighboring cells, and the identified type of range data present in the first data table; and
generating, based on the predicted corrected values, a second data table containing the predicted corrected values in the one or more cells containing the missing and error data, wherein the second data table is a completed version of the first data table.

2. The method of claim 1, wherein predicting the corrected values of the one or more cells containing the missing and error data comprises:
classifying the missing and error data as regular missing data;
applying a K nearest neighbors (KNN) algorithm to the neighboring cells of the one or more cells containing the missing and error data of the first data table; and
deriving a predicted corrected value of the regular missing data from the KNN algorithm.

3. The method of claim 1, wherein predicting the corrected values of the one or more cells containing the missing and error data comprises:
determining the missing and error data is classified as range missing data;
evaluating the similarity between the neighboring cells and the one or more cells containing the range missing data; and
predicting, based on the evaluated similarity, a corrected value of the range missing data.

4. The method of claim 3, wherein performing the second similarity analysis comprises detecting patterns between a first cell and a neighboring second cell of the one or more cells containing the range missing data of the first data table.

5. The method of claim 1, wherein interpreting the meaning of the extracted data further comprises:
interpreting a meaning of numerical data from the plurality of neighboring cells following a detected special character within the first data table,
to detect the missing and error data based on the interpreted meaning of the numerical data.

6. The method of claim 5 wherein interpreting the meaning of the numerical data comprises:
extracting data from a header cell of the first data table;
interpreting the meaning of the extracted data from the header cell; and
predicting the meaning of the detected special character used under the header cell based on the interpreted meaning of the extracted data.

7. The method of claim 1, wherein the type of range data comprises:
formatted range data, wherein the formatted range data is arranged in the first data table with a lower bound column of the range data, and an upper bound column of the range data;
single range data, wherein the single range data is arranged in the first data table as one number indicating a limit in one cell of the first data table; and
comprised range data, wherein the comprised range data is arranged in the first data table as multiple numbers indicating a limit in one cell of the first data table.

8. A computer program product for generating a data table, the computer program product comprising:
a computer-readable storage medium having computer-readable program code embodied therewith, the computer-readable program code executable by one or more computer processors configured to perform operations comprising:
evaluating, using an artificial intelligence (AI) system, a first data table to detect missing and error data and automatically correct data of the first data table, wherein the missing data comprises null cell content and the error data further comprises inconsistent and anomalous cell content, and wherein evaluating the first data table comprises:
performing a first similarity analysis of cell content of a plurality of neighboring cells of the first data table to identify data patterns, relationships, and anomalies that indicate one or more cells containing the missing and error data, wherein performing the first similarity analysis comprises:
interpreting a meaning of the extracted data from the plurality of neighboring cells, header cells; of the first data table, and corresponding numerical data of cells under the header cells to detect the missing and error data based on the interpreted meaning of the extracted data;
evaluating the plurality of neighboring cells of the first data table to identify a type of range data present in the one or more cells containing the missing and error data in the first data table;
predicting corrected values of the one or more cells containing the missing and error data of the first data table by performing a second similarity analysis based on the one or more cells containing the missing and error data, the plurality of neighboring cells, and the identified type of range data present in the first data table; and
generating, based on the predicted corrected values, a second data table containing the predicted corrected values in the one or more cells containing the missing and error data, wherein the second data table is a completed version of the first data table.

9. The computer program product of claim 8, wherein predicting the corrected values of the one or more cells containing the missing and error data comprises:
classifying the missing and error data as regular missing data;
applying a K nearest neighbors (KNN) algorithm to the neighboring cells of the one or more cells containing the missing and error data of the first data table; and
deriving a predicted corrected value of the regular missing data from the KNN algorithm.

10. The computer program product of claim 8, wherein predicting the corrected values of the one or more cells containing the missing and error data comprises:
determining the missing and error data is classified as range missing data;
evaluating the similarity between the neighboring cells and the one or more cells containing the range missing data; and
predicting, based on the evaluated similarity, a corrected value of the range missing data.

11. The computer program product of claim 10, wherein performing the second similarity analysis comprises detecting patterns between a first cell and a neighboring second cell of the one or more cells containing the range missing data of the first data table.

12. The computer program product of claim 8, wherein interpreting the meaning of the extracted data further comprises:
interpreting a meaning of numerical data from the plurality of neighboring cells following a detected special character within the first data table,
to detect the missing and error data based on the interpreted meaning of the numerical data.

13. The computer program product of claim 12, wherein interpreting the meaning of the numerical data comprises:
extracting data from a header cell of the first data table;
interpreting the meaning of the extracted data from the header cell; and
predicting the meaning of the detected special character used under the header cell based on the interpreted meaning of the extracted data.

14. The computer program product of claim 8, wherein the type of range data comprises:
formatted range data, wherein the formatted range data is arranged in the first data table with a lower bound column of the range data, and an upper bound column of the range data;
single range data, wherein the single range data is arranged in the first data table as one number indicating a limit in one cell of the first data table; and
comprised range data, wherein the comprised range data is arranged in the first data table as multiple numbers indicating a limit in one cell of the first data table.

15. A computer system for generating a data table, the computer system comprising:
one or more computer processors;
one or more computer readable storage media; and
program instructions stored on the computer readable storage media for execution by at least one of the one or more processors, the program instructions comprising:
evaluating, using an artificial intelligence (AI) system, a first data table to detect missing and error data and automatically correct data of the first data table, wherein the missing data comprises null cell content and the error data further comprises inconsistent and anomalous cell content, and wherein evaluating the first data table comprises:
performing a first similarity analysis of cell content of a plurality of neighboring cells of the first data table to identify data patterns, relationships, and anomalies that indicate one or more cells containing the missing and error data. wherein performing the first similarity analysis comprises:
interpreting a meaning of extracted data from the plurality of neighboring cells, header cells; of the first data table, and corresponding numerical data of cells under the header cells to detect the missing and error data based on the interpreted meaning of the extracted data;
evaluating the plurality of neighboring cells of the first data table to identify a type of range data present in the one or more cells containing the missing and error data in the first data table;
predicting corrected values of the one or more cells containing the missing and error data of the first data table by performing a second similarity analysis based on the one or more cells containing the missing and error data, the plurality of neighboring cells, and the identified type of range data present in the first data table; and
generating, based on the predicted corrected values, a second data table containing the predicted corrected values in the one or more cells containing the missing and error data, wherein the second data table is a completed version of the first data table.

16. The system of claim 15, wherein predicting the corrected values of the one or more cells containing the missing and error data comprises:
classifying the missing and error data as regular missing data;
applying a K nearest neighbors (KNN) algorithm to the neighboring cells of the one or more cells containing the missing and error data of the first data table; and
deriving a predicted corrected value of the regular missing data from the KNN algorithm.

17. The system of claim 15, wherein predicting the corrected values of the one or more cells containing the missing and error data comprises:
determining the missing and error data is classified as range missing data;
evaluating the similarity between the neighboring cells and the one or more cells containing the range missing data; and
predicting, based on using the evaluated similarity, a corrected value of the range missing data.

18. The system of claim 15, wherein interpreting the meaning of the extracted data further comprises:
interpreting a meaning of numerical data from the plurality of neighboring cells following a detected special character within the first data table,
to detect the missing and error data based on the interpreted meaning of the numerical data.

19. The system of claim 18 wherein interpreting the meaning of the numerical data following the special character comprises:
extracting data from a header cell of the first data table;
interpreting the meaning of the extracted data from the header cell; and
predicting the meaning of special character used under the header cell based on the interpreted meaning of the extracted data.

20. The system of claim 15, wherein the type of range data comprises:
formatted range data, wherein the formatted range data is arranged in the first data table with a lower bound column of the range data, and an upper bound column of the range data;
single range data, wherein the single range data is arranged in the first data table as one number indicating a limit in one cell of the first data table; and
comprised range data, wherein the comprised range data is arranged in the first data table as multiple numbers indicating a limit in one cell of the first data table.
